(19) United States
(12) Patent Application Publication
(10) Pub. No.: US 2020/0115271 A1
(43) Pub. Date: Apr. 16, 2020

(54) OPTICAL GLASS, AND OPTICAL ELEMENT, OPTICAL SYSTEM, CEMENTED LENS, INTERCHANGEABLE CAMERA LENS, AND OPTICAL DEVICE USING SAME

(71) Applicants: HIKARI GLASS CO., LTD., Yuzawa (JP); NIKON CORPORATION, Tokyo (JP)

(72) Inventors: Tetsuya Koide, Yokohama (JP); Noriaki Iguchi, Yokote (JP)

(73) Assignees: HIKARI GLASS CO., LTD., Yuzawa (JP); NIKON CORPORATION, Tokyo (JP)

(21) Appl. No.: 16/714,100

(22) Filed: Dec. 13, 2019

Related U.S. Application Data
(63) Continuation of application No. PCT/JP2018/018307, filed on May 11, 2018.

(30) Foreign Application Priority Data
Jun. 14, 2017 (JP) 2017-116580

(51) Int. Cl. C03C 3/066; G03B 17/14; G02B 9/04

(52) U.S. Cl. CPC C03C 3/066; H04N 5/2254; G02B 9/04; G03B 17/14

(57) ABSTRACT

Provide is an optical glass including: by mass %, 0% to 5% of a SiO₂ component; 10% to 40% of a P₂O₅ component; 4% to 30% of a B₂O₃ component; 0% to 11% of a Na₂O component; 5% to 20% of a K₂O component; 0% to 20% of a TiO₂ component; 0% to 2% of a ZrO₂ component; and 20% to 70% of a Nb₂O₅ component, wherein P₂O₅ component+B₂O₃ component is more than 25% and 41% or less, B₂O₃ component/P₂O₅ component is 0.15 or more and less than 1.23, TiO₂ component/P₂O₅ component is 0 or more and less than 1.3, and Nb₂O₅ component/P₂O₅ component is from 0.7 to 2.8.

### TECHNICAL FIELD

The present invention relates to an optical glass, an optical element, an optical system, a cemented lens, an interchangeable camera lens, and an optical device. The present invention claims priority to Japanese Patent Application No. 2017-116580, filed on Jun. 14, 2017, the contents of which are incorporated by reference herein in its entirety in designated states where the incorporation of documents by reference is approved.

### BACKGROUND ART

In recent years, imaging equipment and the like including an image sensor with a large number of pixels have been developed, and an optical glass that is highly dispersive and low specific gravity has been demanded as an optical glass to be used for such equipment.

### CITATION LIST

### Patent Literature

PTL 1: JP 2006-219365 A

### SUMMARY OF INVENTION

A first aspect according to the present invention is an optical glass including: by mass %, 0% to 5% of a SiO₂ component; 10% to 40% of a P₂O₅ component; 4% to 30% of a B₂O₃ component; 0% to 11% of a Na₂O component; 5% to 20% of a K₂O component; 0% to 20% of a TiO₂ component; 0% to 2% of a ZrO₂ component; and 20% to 70% of a Nb₂O₅ component, wherein P₂O₅ component+B₂O₃ component is more than 25% and 41% or less, B₂O₃ component/P₂O₅ component is 0.15 or more and less than 1.23, TiO₂ component/P₂O₅ component is 0 or more and less than 1.3, and Nb₂O₅ component/P₂O₅ component is from 0.7 to 2.8.

A second aspect according to the present invention is an optical element using the optical glass according to the first aspect.

A third aspect according to the present invention is an optical system including the optical element according to the second aspect.

A fourth aspect according to the present invention is an interchangeable camera lens including the optical system according to the third aspect.

A fifth aspect according to the present invention is an optical device including the optical system according to the third aspect.

A sixth aspect according to the present invention is a cemented lens including a first lens element and a second lens element, and at least one of the first lens element and the second lens element is the optical glass according to the first aspect.

A seventh aspect according to the present invention is an optical system including the cemented lens according to the sixth aspect.

An eighth aspect according to the present invention is an interchangeable camera lens including the optical system according to the seventh aspect.

A ninth aspect according to the present invention is an optical device including the optical system according to the seventh aspect.

### BRIEF DESCRIPTION OF DRAWINGS

FIG. 1 is a perspective view illustrating one example of an optical device according to the present embodiment as an imaging device.

FIGS. 2A and 2B are schematic diagrams illustrating another example of the optical device according to the present embodiment as an imaging device.

FIG. 3 is a block diagram illustrating an example of a configuration of a multi-photon microscope according to the present embodiment.

FIG. 4 is a schematic diagram illustrating one example of a cemented lens according to the present embodiment.

### DESCRIPTION OF EMBODIMENTS

Hereinafter, description is made on an embodiment of the present invention (hereinafter, referred to as the “present embodiment”). The present embodiment described below is an example for describing the present invention, and is not intended to limit the present invention to the contents described below. The present invention may be modified as appropriate and carried out without departing from the gist thereof.

In the present specification, a content amount of each of all the components is expressed with mass % (mass percentage) with respect to the total weight of glass in terms of an oxide-converted composition unless otherwise stated. Note that, assuming that oxides, complex salt, and the like, which are used as raw materials as glass constituent components in the present embodiment, are all decomposed and turned into oxides at the time of melting, the oxide-converted composition described herein is a composition in which each component contained in the glass is expressed with a total mass of the oxides as 100 mass %.

The optical glass according to the present embodiment is an optical glass including: by mass %, 0% to 5% of a SiO₂ component; 10% to 40% of a P₂O₅ component; 4% to 30% of a B₂O₃ component; 0% to 11% of a Na₂O component; 5% to 20% of a K₂O component; 0% to 20% of a TiO₂ component; 0% to 2% of a ZrO₂ component; and 20% to 70% of a Nb₂O₅ component, wherein P₂O₅ component+B₂O₃ component is more than 25% and 41% or less, B₂O₃ component/P₂O₅ component is 0.15 or more and less than 1.23, TiO₂ component/P₂O₅ component is 0 or more and less than 1.3, and Nb₂O₅ component/P₂O₅ component is from 0.7 to 2.8.

Hitherto, a method of increasing a content amount of a component such as TiO₂ and Nb₂O₅ has been attempted in order to achieve high dispersion. However, when the content amounts of those are increased, reduction of a transmittance and increase of specific gravity are liable to be caused. At this viewpoint, the optical glass according to the present embodiment can be highly dispersive and can be reduced in specific gravity. Thus, a light-weighted lens can be achieved.

SiO₂ is a component that improves chemical durability but degrades devitrification resistance. When the content amount of SiO₂ is excessively increased, devitrification resistance is liable to be degraded. From such viewpoint, the content amount of SiO₂ is 0% or more and less than 5%, preferably from 0% to 4%, more preferably from 0% to 3%. When the content amount of SiO₂ falls within such range, devitrification resistance can be improved, and chemical durability can be satisfactory.

P₂O₅ is a component that forms a glass frame, improves devitrification resistance, reduces a refractive index, and degrades chemical durability. When the content amount of P₂O₅ is excessively reduced, devitrification is liable to be caused. When the content amount of P₂O₅ is excessively increased, a refractive index is liable to be reduced, and chemical durability is liable to be degraded. From such viewpoint, the content amount of P₂O₅ is from 10% to 40%, preferably from 20% to 30%, more preferably from 20% to 25%. When the content amount of P₂O₅ falls within such range, devitrification resistance can be improved, chemical durability can be satisfactory, and a refractive index can be increased.

B₂O₃ is a component that forms a glass frame, improves devitrification resistance, reduces a refractive index, and degrades chemical durability. When the content amount of B₂O₃ is excessively reduced, meltability is liable to be degraded, and devitrification is also liable to be caused. When the content amount of B₂O₃ is excessively increased, a refractive index is liable to be reduced, and chemical durability is liable to be degraded. From such viewpoint, the content amount of B₂O₃ is from 4% to 30%, preferably from 10% to 20%, more preferably from 10% to 18%. When the content amount of B₂O₃ falls within such range, devitrification resistance can be improved, chemical durability can be satisfactory, and a refractive index can be increased.

Na₂O is a component that improves meltability and reduces a refractive index. When the content amount of Na₂O is excessively increased, a refractive index is liable to be reduced. From such viewpoint, the content amount of Na₂O is from 0% to 11%, preferably from 1% to 8%, more preferably from 1% to 5%. When the content amount of Na₂O falls within such range, reduction of a refractive index can be prevented.

K₂O is a component that improves meltability, reduces a refractive index, and degrades chemical durability. The content amount of K₂O is from 5% to 20%, preferably from 7% to 20%, more preferably from 10% to 20%. When the content amount of K₂O falls within such range, high chemical durability can be achieved without reducing a refractive index.

TiO₂ is a component that increases a refractive index and reduces a transmittance. When the content amount of TiO₂ is increased, a transmittance is liable to be degraded. From such viewpoint, the content amount of TiO₂ is from 0% to 20%, preferably from 0% to 15%, more preferably from 1% to 10%. When the content amount of TiO₂ falls within such range, a high transmittance can be achieved without reducing a refractive index.

ZrO₂ is a component that increases a refractive index, and degrades devitrification resistance. When the content amount of ZrO₂ is increased, the glass is liable to be devitrified. From such viewpoint, the content amount of ZrO₂ is from 0% to 2%, preferably from 0% to 1.5%, more preferably from 0% to 1%.

Nb₂O₅ is a component that increases a refractive index, improves dispersion, and reduces a transmittance. When the content amount of Nb₂O₅ is reduced, a refractive index is liable to be reduced. When the content amount of Nb₂O₅ is increased, a transmittance is liable to be degraded. From such viewpoint, the content amount of Nb₂O₅ is from 20% to 70%, preferably from 30% to 60%, more preferably from 30% to 55%. When the content amount of Nb₂O₅ falls within such range, a high transmittance can be achieved without reducing a refractive index and degrading dispersion.

The sum of the content amounts of P₂O₅ and B₂O₃ (P₂O₅+B₂O₃) is more than 25% and 41% or less, preferably from 30% to 41%. When P₂O₅+B₂O₃ falls within such range, a refractive index can be increased.

The ratio of the content amount of B₂O₃ to the content amount P₂O₅ (B₂O₃/P₂O₅) is from 0.15 to less than 1.23, preferably from 0.2 to 1, more preferably from 0.45 to 1. When B₂O₃/P₂O₅ falls within such range, a refractive index can be increase.

The ratio of the content amount of TiO₂ to the content amount of P₂O₅ (TiO₂/P₂O₅) is from 0 to less than 1.3, preferably from 0 to 1, more preferably from 0% to 0.5. When TiO₂/P₂O₅ falls within such range, a refractive index and a transmittance can be increased.

The ratio of the content amount of Nb₂O₅ to the content amount of P₂O₅ (Nb₂O₅/P₂O₅) is from 0.7 to 2.8, preferably from 0.7 to 2.5, more preferably from 0.7 to 2.4. When Nb₂O₅/P₂O₅ falls within such range, a refractive index and a transmittance can be increased.

The optical glass according to the present embodiment may further include, as an optional component, one or more kinds selected from a group consisting of Li₂O, MgO, CaO, SrO, BaO, ZnO, Al₂O₃, Y₂O₃, La₂O₃, Gd₂O₃, Sb₂O₃, WO₃, and Ta₂O₅.

The content amount of Li₂O is, from a viewpoint of meltability, preferably from 0% to 10%, more preferably from 0% to 5%, further preferably from 0% to 2%.

The content amount of MgO is, from a viewpoint of high dispersion, preferably from 0% to 20%, more preferably from 0% to 15%, further preferably from 0% to 10%.

The content amount of CaO is, from a viewpoint of high dispersion, preferably from 0% to 20%, more preferably from 0% to 15%, further preferably from 0% to 10%.

The content amount of SrO is, from a viewpoint of high dispersion, preferably from 0% to 20%, more preferably from 0% to 15%, further preferably from 0% to 10%.

The content amount of BaO is, from a viewpoint of high dispersion, preferably from 0% to 20%, more preferably from 0% to 10%, further preferably from 0% to 5%.

The content amount of ZnO is, from a viewpoint of high dispersion, preferably from 0% to 20%, more preferably from 0% to 10%, further preferably from 0% to 5%.

The content amount of Al₂O₃ is, from a viewpoint of meltability, preferably from 0% to 10%, more preferably from 0% to 7%, further preferably from 0% to 2%.

The content amount of Y₂O₃ is, from a viewpoint of meltability, preferably from 0% to 10%, more preferably from 0% to 7%, further preferably from 0% to 5%.

The content amount of La₂O₃ is, from a viewpoint of meltability, preferably from 0% to 10%, more preferably from 0% to 7%, further preferably from 0% to 5%. From a viewpoint of cost, La₂O₃ is not substantially included, which is more preferably.

Gd₂O₃ is an expensive raw material, and hence the content amount thereof is preferably from 0% to 10%, more preferably from 0% to 7%, further preferably from 0% to 5%.

The content amount of Sb₂O₃ is, from a viewpoint of a defoaming property at the time of melting of glass, preferably from 0% to 1%.

The content amount of WO₃ is, from a viewpoint of a transmittance, preferably from 0% to 10%, more preferably from 0% to 7%, further preferably from 0% to 2%.

Ta₂O₅ is an expensive raw material, and hence the content amount thereof is preferably from 0% to 5%, and more preferably, is not substantially included. From such viewpoint, Ta is not included substantially in the present embodiment, which is preferable.

A suitable combination of the content amounts of those is 0% to 10% of the Li₂O component, 0% to 20% of the MgO component, 0% to 20% of the CaO component, 0% to 20% of the SrO component, 0% to 20% of the BaO component, 0% to 20% of the ZnO component, 0% to 10% of the Al₂O₃ component, 0% to 10% of the Y₂O₃ component, 0% to 10% of the La₂O₃ component, 0% to 10% of the Gd₂O₃ component, 0% to 1% of the Sb₂O₃ component, 0% to 10% of the WO₃ component, and 0% to 5% of the Ta₂O₅ component.

In the optical glass according to the present embodiment, P₂O₅, B₂O₃, Na₂O, K₂O, TiO₂, and Nb₂O₅ preferably satisfy the following relationships.

The ratio of the sum of the content amounts of Na₂O and K₂O (Na₂O+K₂O) to the sum of the content amounts of P₂O₅ and B₂O₃ (P₂O₅+B₂O₃) ((Na₂O+K₂O)/(P₂O₅+B₂O₃)) is preferably from 0.2 to 0.8, more preferably from 0.3 to 0.6. When (Na₂O+K₂O)/(P₂O₅+B₂O₃) falls within such range, high dispersion can be achieved.

The ratio of the sum of the content amounts of TiO₂ and Nb₂O₅ (TiO₂+Nb₂O₅) to the sum of the content amounts of P₂O₅ and B₂O₃ (P₂O₅+B₂O₃) ((TiO₂+Nb₂O₅)/(P₂O₅+B₂O₃)) is preferably from 0.9 to 1.6, more preferably from 1 to 1.5. When (TiO₂+Nb₂O₅)/(P₂O₅+B₂O₃) falls within such range, high dispersion can be achieved.

A suitable combination of the conditions described above is 0.2 to 0.8 of (Na₂O+K₂O)/(P₂O₅+B₂O₃) and 0.9 to 1.6 of (TiO₂+Nb₂O₅)/(P₂O₅+B₂O₃).

Note that, for the purpose of, for example, performing fine adjustments of fining, coloration, decoloration, and optical constant values, a known component such as a fining agent, a coloring agent, a defoaming agent, and a fluorine compound may be added by an appropriate amount to the glass composition as needed. In addition to the above-mentioned components, other components may be added as long as the effect of the optical glass according to the present embodiment can be exerted.

A method of manufacturing the optical glass according to the present embodiment is not particularly limited, and a publicly known method may be adopted. Further, suitably conditions can be selected for the manufacturing conditions as appropriate. For example, there may be adopted a manufacturing method in which raw materials such as oxides, carbonates, nitrates, and sulfates are blended to obtain a target composition, melted at a temperature of preferably from 1,100 to 1,400 degrees Celsius, more preferably from 1,200 to 1,300 degrees Celsius, uniformed by stirring, subjected to defoaming, then poured in a mold, and molded. The optical glass thus obtained is processed to have a desired shape by performing re-heat pressing or the like as needed, and is subjected to polishing. With this, a desired optical element is obtained.

A high-purity material with a small content amount of impurities is preferably used as the raw material. The high-purity material indicates a material including 99.85 mass % or more of a concerned component. By using the high-purity material, an amount of impurities is reduced, and hence an inner transmittance of the optical glass is likely to be increased.

Next, description is made on physical properties of the optical glass according to the present embodiment.

From a viewpoint of reduction in thickness of the lens, the optical glass according to the present embodiment preferably has a high refractive index (a refractive index (n_{d}) is large). However, in general, as the refractive index (n_{d}) is higher, the specific gravity is liable to be increased. In view of such circumstance, the refractive index (n_{d}) of the optical glass according to the present embodiment with respect to a d-line preferably falls within a range from 1.70 to 1.78, more preferably, a range from 1.72 to 1.77.

An abbe number (ν_{d}) of the optical glass according to the present embodiment preferably falls within a range from 20 to 30, more preferably, a range from 22 to 27. With regard to the optical glass according to the present embodiment, a preferably combination of the refractive index (n_{d}) and the abbe number (ν_{d}) is the refractive index (n_{d}) with respect to the d-line falling within a range from 1.70 to 1.78 and the abbe number (ν_{d}) falling within a range from 20 to 30. An optical system in which chromatic aberration and other aberrations are satisfactorily corrected can be designed by, for example, combining the optical glass according to the present embodiment having such properties with other optical glasses.

From a viewpoint of correction of chromatic aberration, in the optical glass according to the present embodiment, the refractive index (n_{d}) with respect to the d-line and the abbe number (ν_{d}) preferably satisfy a relationship that ν_{d}+40×n_{d}-96.4 is 0 or less.

From a viewpoint of reduction in weight of the lens, the optical glass according to the present embodiment preferably has low specific gravity. However, in general, as the specific gravity is increased, a refractive index is liable to be reduced. In view of such circumstance, suitable specific gravity (S_{g}) of the optical glass according to the present embodiment falls within a range with a lower limit of 2.9 and an upper limit of 3.6, i.e., from 2.9 to 3.6.

From a viewpoint of aberration correction of the lens, the optical glass according to the present embodiment preferably has a large partial dispersion ratio (Pg, F). In view of such circumstance, the partial dispersion ratio (Pg, F) of the optical glass according to the present embodiment is preferably 0.6 or more.

From a viewpoint of a visible light transmittance of the optical system, in the optical glass according to the present embodiment, a wavelength (λ₈₀) at which an inner transmittance in a case of an optical path length of 10 mm is 80% is preferably 450 nm or less, more preferably from 430 nm or less.

The optical glass according to the present embodiment enables a content amount of Ta₂O₅ or the like being an expensive raw material to be reduced, and further enables such material to be excluded. Thus, the optical glass according to the present embodiment is also excellent in reduction of raw material cost.

From the above-mentioned viewpoint, the optical glass according to the present embodiment can be suitably used as, for example, an optical element included in an optical device. Among optical devices, an imaging device and a multi-photon microscope are especially suitable.

### <Imaging Device>

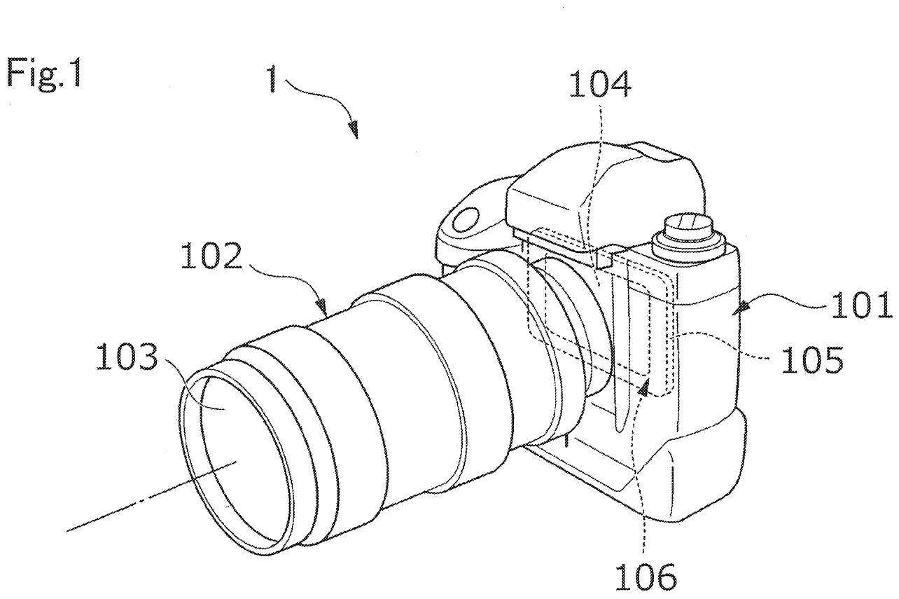

FIG. 1 is a perspective view illustrating one example of an optical device as an imaging device. An imaging device 1 is a so-called digital single-lens reflex camera (a lens-interchangeable camera), and a photographing lens 103 (an optical system) includes, as a base material, an optical element including the optical glass according to the present embodiment. A lens barrel 102 is mounted to a lens mount (not illustrated) of a camera body 101 in a removable manner. Further, an image is formed with light, which passes through the lens 103 of the lens barrel 102, on a sensor chip (solid-state imaging elements) 104 of a multi-chip module 106 arranged on a back surface side of the camera body 101. The sensor chip 104 is a so-called bare chip such as a CMOS image sensor, and the multi-chip module 106 is, for example, a Chip On Glass (COG) type module including the sensor chip 104 being a bare chip mounted on a glass substrate 105.

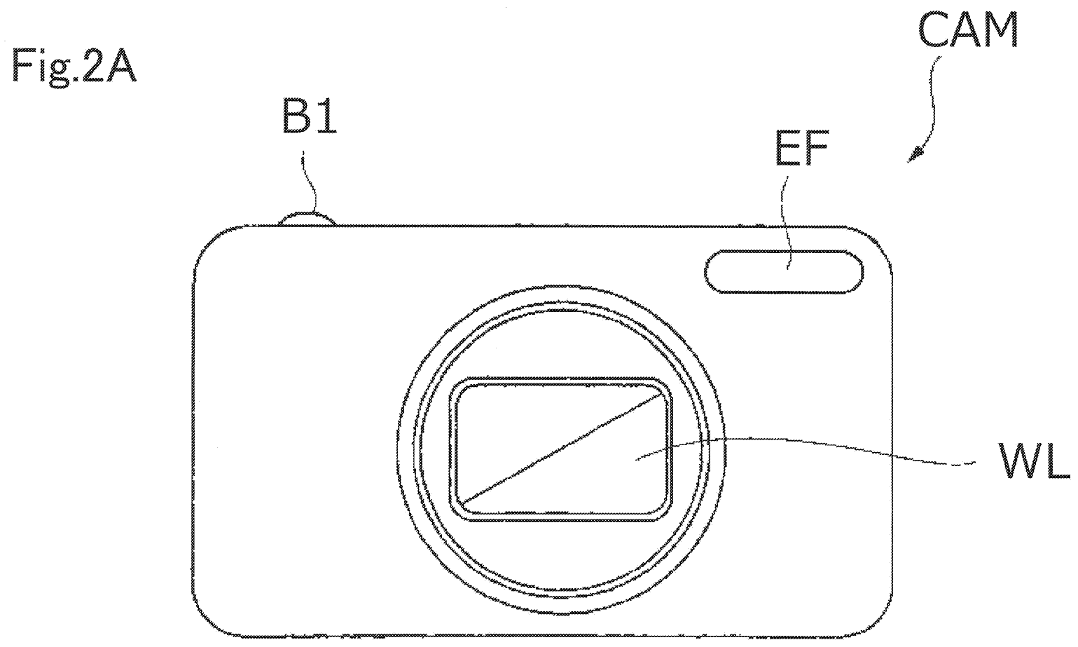

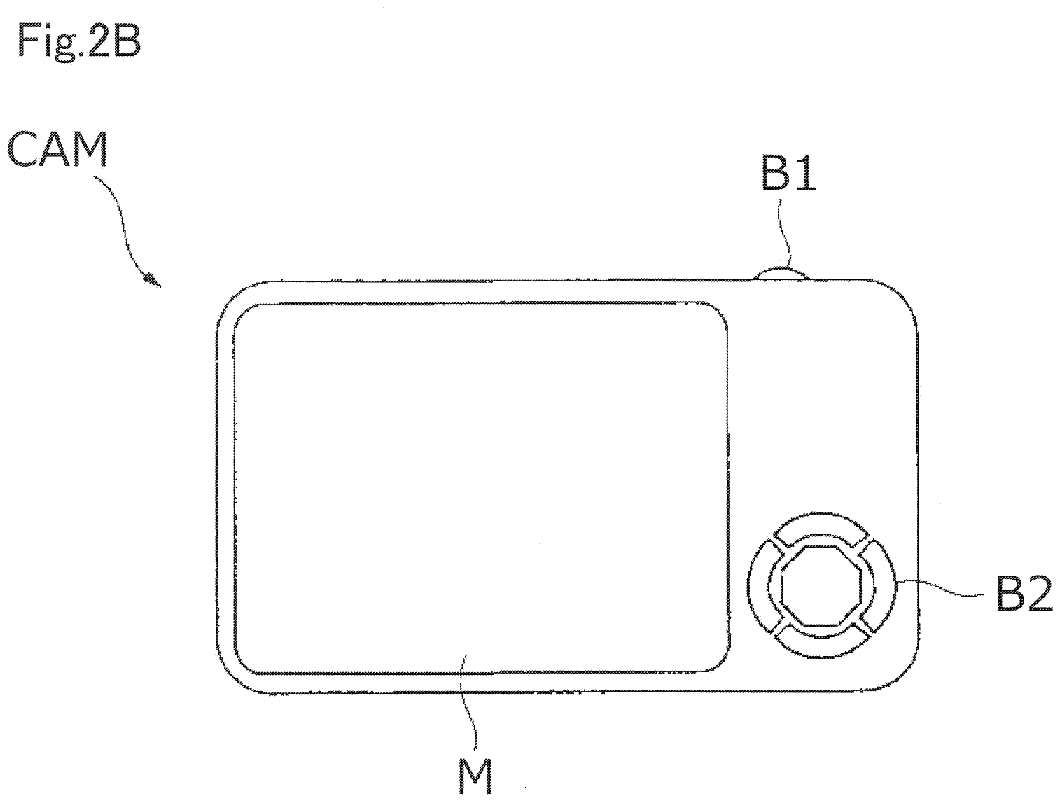

FIGS. 2A and 2B are schematic diagrams illustrating another example of the optical device as the imaging device. FIG. 2A is a front view of an imaging device CAM, and FIG. 2B is a back view of the imaging device CAM. The imaging device CAM is a so-called digital still camera (a fixed lens camera), and a photographing lens WL (an optical system) includes an optical element including the optical glass according to the present embodiment, as a base material.

When a power button (not illustrated) of the imaging device CAM is pressed, a shutter (not illustrated) of the photographing lens WL is opened, light from an object to be imaged (a body) is converged by the photographing lens WL and forms an image on imaging elements arranged on an image surface. An object image formed on the imaging elements is displayed on a liquid crystal monitor M arranged on the back of the imaging device CAM. A photographer decides composition of the object image while viewing the liquid crystal monitor M, then presses down a release button B1, and captures the object image on the imaging elements. The object image is recorded and stored in a memory (not illustrated).

An auxiliary light emitting unit EF that emits auxiliary light in a case that the object is dark and a function button B2 to be used for setting various conditions of the imaging device CAM and the like are arranged on the imaging device CAM.

A higher resolution, lighter weight, and a smaller size are demanded for the optical system to be used in such digital camera or the like. In order to achieve such demands, it is effective to use glass with a high refractive index as the optical system. Particularly, glass that achieves both a high refractive index and lower specific gravity (S_{g}) and has high press formability is highly demanded. From such viewpoint, the optical glass according to the present embodiment is suitable as a member of such optical device. Note that, in addition to the imaging device described above, examples of the optical device to which the present embodiment is applicable include a projector and the like. In addition to the lens, examples of the optical element include a prism and the like.

### <Multi-Photon Microscope>

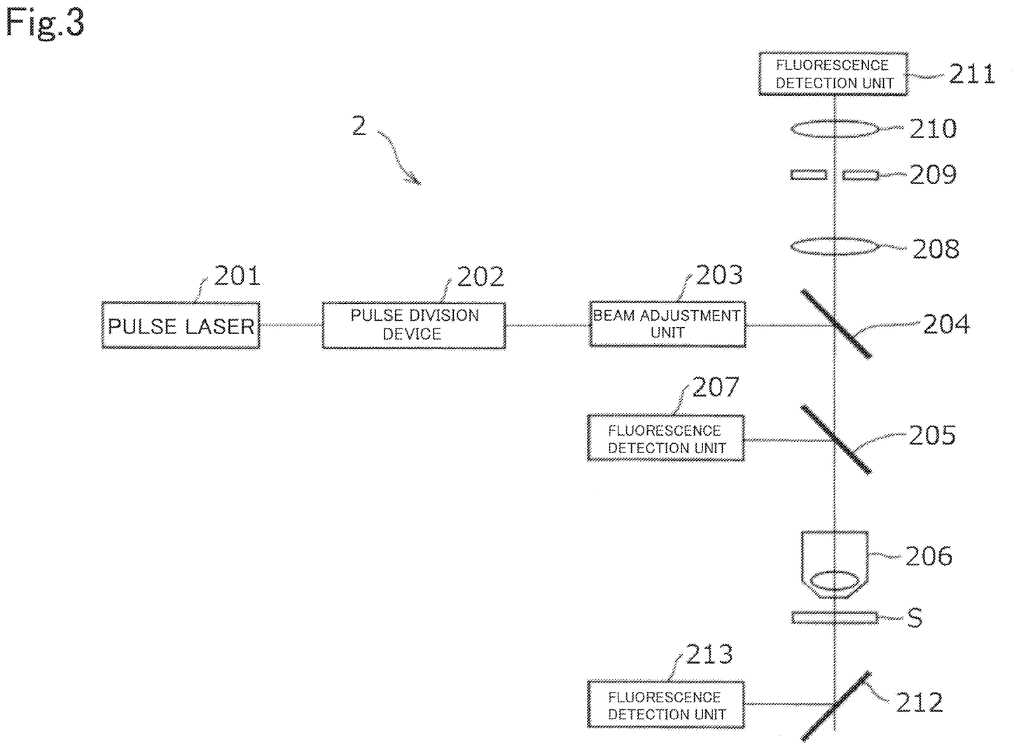

FIG. 3 is a block diagram illustrating an example of a configuration of a multi-photon microscope 2. The multi-photon microscope 2 includes an objective lens 206, a condensing lens 208, and an image forming lens 210. At least one of the objective lens 206, the condensing lens 208, and the image forming lens 210 includes an optical element including, as a base material, the optical glass according to the present embodiment. Hereinafter, description is mainly made on the optical system of the multi-photon microscope 2.

A pulse laser device 201 emits ultrashort pulse light having, for example, a near infrared wavelength (approximately 1,000 nm) and a pulse width of a femtosecond unit (for example, 100 femtoseconds). In general, ultrashort pulse light immediately after being emitted from the pulse laser device 201 is linearly polarized light that is polarized in a predetermined direction.

A pulse division device 202 divides the ultrashort pulse light, increases a repetition frequency of the ultrashort pulse light, and emits the ultrashort pulse light.

A beam adjustment unit 203 has a function of adjusting a beam diameter of the ultrashort pulse light, which enters from the pulse division device 202, to a pupil diameter of the objective lens 206, a function of adjusting convergence and divergence angles of the ultrashort pulse light in order to correct chromatic aberration (a focus difference) on an axis of a wavelength of multi-photon excitation light emitted from a sample S and the wavelength of the ultrashort pulse light, a pre-chirp function (group velocity dispersion compensation function) providing inverse group velocity dispersion to the ultrashort pulse light in order to correct the pulse width of the ultrashort pulse light, which is increased due to group velocity dispersion at the time of passing through the optical system, and the like.

The ultrashort pulse light emitted from the pulse laser device 201 have a repetition frequency increased by the pulse division device 202, and is subjected to the above-mentioned adjustments by the beam adjustment unit 203. Furthermore, the ultrashort pulse light emitted from the beam adjustment unit 203 is reflected on a dichroic mirror 204 in a direction toward a dichroic mirror 205, passes through the dichroic mirror 205, is converged by the objective lens 206, and is radiated to the sample S. At this time, an observation surface of the sample S may be scanned with the ultrashort pulse light through use of scanning means (not illustrated).

For example, when the sample S is subjected to fluorescence imaging, a fluorescent pigment by which the sample S is dyed is subjected to multi-photon excitation in an irradiated region with the ultrashort pulse light and the vicinity thereof on the sample S, and fluorescence having a wavelength shorter than a near infrared wavelength of the ultrashort pulse light (hereinafter, also referred to “observation light”) is emitted.

The observation light emitted from the sample S in a direction toward the objective lens 206 is collimated by the objective lens 206, and is reflected on the dichroic mirror 205 or passes through the dichroic mirror 205 depending on the wavelength.

The observation light reflected on the dichroic mirror 205 enters a fluorescence detection unit 207. For example, the fluorescence detection unit 207 is formed of a barrier filter, a photo multiplier tube (PMT), or the like, receives the observation light reflected on the dichroic mirror 205, and outputs an electronic signal depending on an amount of the light. The fluorescence detection unit 207 detects the observation light over the observation surface of the sample S, in conformity with the ultrashort pulse light scanning on the observation surface of the sample S.

Meanwhile, the observation light passing through the dichroic mirror 205 is de-scanned by scanning means (not illustrated), passes through the dichroic mirror 204, is converged by the condensing lens 208, passes through a pinhole 209 provided at a position substantially conjugate to a focal position of the objective lens 206, passes through the image forming lens 210, and enters a fluorescence detection unit 211.

For example, the fluorescence detection unit 211 is formed of a barrier filter, a PMT, or the like, receives the observation light forming an image formed by the image forming lens 210 on a light reception surface of the fluorescence detection unit 211, and outputs an electronic signal depending on an amount of the light. The fluorescence detection unit 211 detects the observation light over the observation surface of the sample S, in conformity with the ultrashort pulse light scanning on the observation surface of the sample S.

Note that, all the observation light emitted from the sample S in a direction toward the objective lens 206 may be detected by the fluorescence detection unit 211 by excluding the dichroic mirror 205 from the optical path.

The observation light emitted from the sample S in a direction opposite to the objective lens 206 is reflected on a dichroic mirror 212, and enters a fluorescence detection unit 213. The fluorescence detection unit 213 is formed of, for example, a barrier filter, a PMT, or the like, receives the observation light reflected on the dichroic mirror 212, and outputs an electronic signal depending on an amount of the light. Further, the fluorescence detection unit 213 detects the observation light over the observation surface of the sample S, in conformity with the ultrashort pulse light scanning on the observation surface of the sample S.

The electronic signals output from the fluorescence detection units 207, 211, and 213 are input to, for example, a computer (not illustrated). The computer is capable of generating an observation image, displaying the generated observation image, storing data on the observation image, based on the input electronic signals.

### <Cemented Lens>

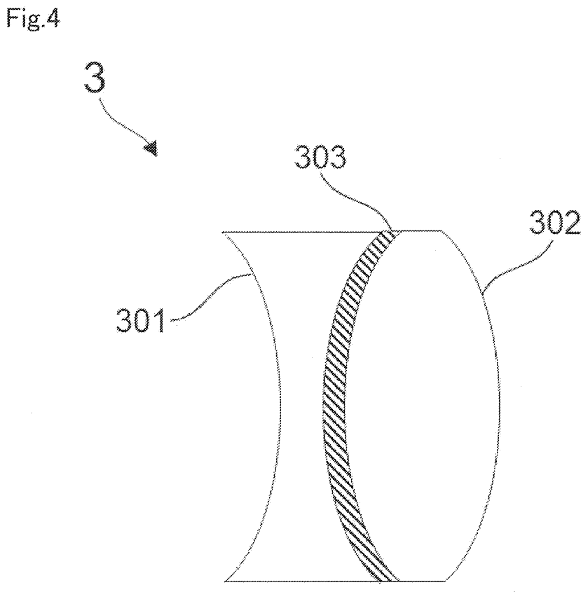

FIG. 4 is a schematic diagram illustrating one example of a cemented lens according to the present embodiment. A cemented lens 3 is a compound lens including a first lens element 301 and a second lens element 302. The optical glass according to the present embodiment is used as at least one of the first lens element and the second lens element. The first lens element and the second lens element are joined through intermediation with a joining member 303. As the joining member 303, a publicly known adhesive agent or the like may be used. Note that, the lenses forming the cemented lens are referred to as “lens elements” as described above in some cases from a viewpoint of clearly stating that the lenses are the elements of the cemented lens.

The cemented lens according to the present embodiment is effective in view of correction of chromatic aberration, and can be used suitably for the optical element, the optical system, and the optical device that are described above and the like. Furthermore, the optical system including the cemented lens can be used suitably for, especially, an interchangeable camera lens and an optical device. Note that, in the aspect described above, description is made on the cemented lens using the two lens elements. The present invention is however not limited thereto, and a cemented lens using three or more lens elements may be used. When the cemented lens uses three or more lens elements, it is only required that at least one of the three or more lens elements be formed by using the optical glass according to the present embodiment.

### EXAMPLES

Next, description is made on Examples in the present invention and Comparative Examples. Each table illustrates a composition of components by mass % in terms of an oxide and evaluation results of physical properties for optical glass produced in Examples. Note that, the present invention is not limited thereto.

### <Production of Optical Glasses>

The optical glasses in Examples and Comparative Examples were produced by the following procedures. First, glass raw materials selected from oxides, hydroxides, phosphate compounds (phosphates, orthophosphoric acids, and the like), carbonates, nitrates, and the like were weighed so as to obtain the compositions (mass %) illustrated in each table. Next, the weighed raw materials were mixed and put in a platinum crucible, melted at a temperature of from 1,100 to 1,300 degrees Celsius, and uniformed by stirring. After defoaming, the resultant was lowered to an appropriate temperature, poured in a mold, annealed, and molded. In this manner, each sample was obtained.

1. Refractive Index (n_{d}) and Abbe Number (ν_{d})

The refractive index (n_{d}) and the abbe number (ν_{d}) in each of the samples were measured and calculated through use of a refractive index measuring instrument (KPR-2000 manufactured by Shimadzu Device Corporation). n_{d} indicates a refractive index of the glass with respect to light of 587.562 nm. ν_{d} was obtained based on Expression (1) given below. nC and nF indicates refractive indexes of the glass with respect to light having a wavelength of 656.273 nm and light having a wavelength of 486.133 nm, respectively.

ν_{d}=(n_{d}−1)/(nF−nC) (1)

### 2. Partial Dispersion Ratio (Pg, F)

The partial dispersion ratio (Pg, F) in each of the samples indicates a ratio of partial dispersion (ng−nF) to main dispersion (nF−nC), and was obtained based on Expression (2) given below. ng indicates a refractive index of the glass with respect to light having a wavelength of 435.835 nm. A value of the partial dispersion ratio (Pg, F) was truncated to the fourth decimal place.

Pg,F=(ng−nF)/(nF−nC) (2)

3. Wavelength (λ₈₀) at which Inner Transmittance is 80%

Optical glass samples that were optically polished to have a thickness of 12 mm and a thickness of 2 mm and were parallel with each other were prepared. An inner transmittance was measured within a wavelength range from 200 to 700 nm when light entered in parallel with a thickness direction. Furthermore, a wavelength at which an inner transmittance is 80% in a case of an optical path length of 10 mm was measured as λ₈₀.

### 4. Specific Gravity (S_{g})

The specific gravity (S_{g}) in each of the samples was obtained based on a mass ratio with respect to pure water having the same volume at 4 degrees Celsius.

TABLE 1

| | Example 1 | Example 2 | Example 3 | Example 4 | Example 5 | Example 6 |
|---|---|---|---|---|---|---|
| P₂O₅ | 22.91 | 21.31 | 22.59 | 22.75 | 21.39 | 20.70 |
| SiO₂ | | | | | | |
| B₂O₃ | 14.68 | 13.66 | 14.48 | 14.58 | 13.71 | 13.27 |
| Na₂O | 2.49 | 2.32 | 2.46 | 3.84 | 2.33 | 2.25 |
| K₂O | 13.99 | 13.01 | 13.79 | 11.82 | 13.06 | 12.64 |
| BaO | | | | | | |
| ZnO | | | | | | |
| Al₂O₃ | | | | | | |
| TiO₂ | 8.78 | | | | 2.75 | 0.15 |
| ZrO₂ | | | | | | |
| Nb₂O₅ | 37.06 | 49.61 | 46.59 | 46.92 | 46.67 | 51.00 |
| WO₃ | | | | | | |
| Sb₂O₃ | 0.09 | 0.09 | 0.09 | 0.09 | 0.09 | |
| total | 100.00 | 100.00 | 100.00 | 100.00 | 100.00 | 100.00 |
| P₂O₅ + B₂O₃ | 37.59 | 34.97 | 37.07 | 37.33 | 35.10 | 33.96 |
| B₂O₃/P₂O₅ | 0.64 | 0.64 | 0.64 | 0.64 | 0.64 | 0.64 |
| TiO₂/P₂O₅ | 0.38 | 0.00 | 0.00 | 0.00 | 0.13 | 0.01 |
| Nb₂O₅/P₂O₅ | 1.62 | 2.33 | 2.06 | 2.06 | 2.18 | 2.46 |
| (Na₂O + K₂O)/(P₂O₅ + B₂O₃) | 0.44 | 0.44 | 0.44 | 0.42 | 0.44 | 0.44 |
| (TiO₂ + Nb₂O₅)/(P₂O₅ + B₂O₃) | 1.22 | 1.42 | 1.26 | 1.26 | 1.41 | 1.51 |
| n_{d} − 1.780000 | −0.023484 | −0.018199 | −0.041826 | −0.037587 | −0.011399 | −0.004929 |
| v_{d} + 40n_{d} − 96.4 | −2.50 | −1.22 | −0.62 | −0.71 | −1.80 | −1.42 |
| n_{d} | 1.756516 | 1.761801 | 1.738174 | 1.742413333 | 1.768601333 | 1.775071 |
| v_{d} | 23.63 | 24.71 | 26.25 | 26.00 | 23.85 | 23.98 |
| Pg. F | 0.6301 | 0.6212 | 0.6144 | 0.6150 | 0.6259 | 0.6257 |
| λ₈₀ | 431 | 421 | 412 | 418 | 428 | 433 |
| S_{g} | 3.05 | 3.17 | 3.11 | 3.13 | 3.15 | 3.19 |

TABLE 2

| | Example 7 | Example 8 | Example 9 | Example 10 | Example 11 | Example 12 |
|---|---|---|---|---|---|---|
| P₂O₅ | 22.74 | 21.33 | 17.75 | 21.98 | 20.60 | 24.94 |
| SiO₂ | 3.64 | | | | | |
| B₂O₃ | 10.36 | 13.67 | 17.59 | 10.02 | 13.20 | 12.78 |
| Na₂O | 2.47 | 2.32 | 2.53 | 4.66 | 2.24 | 1.29 |
| K₂O | 13.89 | 13.03 | 14.19 | 14.11 | 12.58 | 10.18 |
| BaO | | | | | | |
| ZnO | | | | | | |
| Al₂O₃ | | | | | | |
| TiO₂ | | | | | 0.61 | 0.56 |
| ZrO₂ | | | | | | |
| Nb₂O₅ | 46.90 | 49.65 | 47.94 | 49.23 | 50.76 | 50.16 |
| WO₃ | | | | | | |
| Sb₂O₃ | | | | | | 0.08 |
| total | 100.00 | 100.00 | 100.00 | 100.00 | 100.00 | 100.00 |
| P₂O₅ + B₂O₃ | 33.10 | 35.00 | 35.34 | 32.00 | 33.80 | 37.72 |
| B₂O₃/P₂O₅ | 0.46 | 0.64 | 0.99 | 0.46 | 0.64 | 0.51 |
| TiO₂/P₂O₅ | 0.00 | 0.00 | 0.00 | 0.00 | 0.03 | 0.02 |
| Nb₂O₅/P₂O₅ | 2.06 | 2.33 | 2.70 | 2.24 | 2.46 | 2.01 |
| (Na₂O + K₂O)/(P₂O₅ + B₂O₃) | 0.49 | 0.44 | 0.47 | 0.59 | 0.44 | 0.30 |
| (TiO₂ + Nb₂O₅)/(P₂O₅ + B₂O₃) | 1.42 | 1.42 | 1.36 | 1.54 | 1.52 | 1.34 |
| n_{d} − 1.780000 | −0.042904 | −0.018396 | −0.033453 | −0.026986 | −0.002455 | −0.004938 |
| v_{d} + 40n_{d} − 96.4 | −0.05 | −1.23 | −1.50 | −0.35 | −1.58 | −1.53 |
| n_{d} | 1.7370965 | 1.761604 | 1.746547 | 1.753014 | 1.777545 | 1.775062 |
| v_{d} | 26.87 | 24.70 | 25.04 | 25.93 | 23.72 | 23.87 |
| Pg. F | 0.6098 | 0.6241 | 0.6184 | 0.6128 | 0.6271 | 0.6241 |
| λ₈₀ | 389 | 419 | 390 | 393 | 432 | 430 |
| S_{g} | 3.15 | 3.16 | 3.10 | 3.20 | 3.19 | 3.17 |

TABLE 3

| | Example 13 | Example 14 | Example 15 | Example 16 | Example 17 | Example 18 |
|---|---|---|---|---|---|---|
| P₂O₅ | 21.20 | 24.14 | 23.93 | 26.96 | 23.28 | 21.90 |
| SiO₂ | | | | | 3.71 | |
| B₂O₃ | 10.40 | 11.00 | 15.34 | 12.39 | 10.62 | 14.04 |
| Na₂O | 4.49 | 2.21 | 2.60 | 2.46 | 2.53 | |
| K₂O | 13.61 | 12.38 | 14.61 | 13.82 | 14.22 | 17.00 |
| BaO | | | | | | |
| ZnO | | | | | | |
| Al₂O₃ | | | | | | |
| TiO₂ | | 0.32 | 9.17 | 8.67 | 8.92 | |
| ZrO₂ | | | | | | |
| Nb₂O₅ | 50.29 | 49.96 | 34.21 | 35.56 | 36.57 | 47.06 |
| WO₃ | | | | | | |
| Sb₂O₃ | | | 0.15 | 0.14 | 0.14 | |
| total | 100.00 | 100.00 | 100.00 | 100.00 | 100.00 | 100.00 |
| P₂O₅ + B₂O₃ | 31.60 | 35.14 | 39.26 | 39.35 | 33.90 | 35.94 |
| B₂O₃/P₂O₅ | 0.49 | 0.46 | 0.64 | 0.46 | 0.46 | 0.64 |
| TiO₂/P₂O₅ | 0.00 | 0.01 | 0.38 | 0.32 | 0.38 | 0.00 |
| Nb₂O₅/P₂O₅ | 2.37 | 2.07 | 1.43 | 1.32 | 1.57 | 2.15 |
| (Na₂O + K₂O)/(P₂O₅ + B₂O₃) | 0.57 | 0.42 | 0.44 | 0.41 | 0.49 | 0.47 |
| (TiO₂ + Nb₂O₅)/(P₂O₅ + B₂O₃) | 1.59 | 1.43 | 1.10 | 1.12 | 1.34 | 1.31 |
| n_{d} − 1.780000 | −0.015621 | −0.012083 | −0.040008 | −0.032132 | −0.023787 | −0.044664 |
| v_{d} + 40n_{d} − 96.4 | −0.58 | −0.83 | −2.41 | −1.88 | −1.99 | −0.65 |
| n_{d} | 1.764379 | 1.767917 | 1.739992 | 1.747868 | 1.756213 | 1.735336 |
| v_{d} | 25.24 | 24.85 | 24.39 | 24.60 | 24.16 | 26.34 |
| Pg. F | 0.6140 | 0.6183 | 0.6286 | 0.6289 | 0.6263 | 0.6099 |
| λ₈₀ | 393 | 397 | 430 | 434 | 433 | 396 |
| S_{g} | 3.23 | 3.20 | 3.00 | 3.06 | 3.08 | 3.10 |

TABLE 4

| | Example 19 | Example 20 | Example 21 | Example 22 | Example 23 | Example 24 |
|---|---|---|---|---|---|---|
| P₂O₅ | 32.37 | 31.37 | 28.77 | 28.60 | 28.64 | 28.94 |
| SiO₂ | | | | | 1.58 | 3.04 |
| B₂O₃ | 7.66 | 7.42 | 7.99 | 6.61 | 4.91 | 5.61 |
| Na₂O | 9.74 | 9.44 | 7.98 | 10.11 | 10.12 | 9.49 |
| K₂O | 10.71 | 10.38 | 11.18 | 7.81 | 7.82 | 6.90 |
| BaO | 1.81 | 1.76 | 1.89 | 1.88 | 1.89 | 9.07 |
| ZnO | | 1.03 | 1.11 | 1.10 | 1.10 | |
| Al₂O₃ | 0.72 | 0.70 | 0.75 | 0.75 | 0.75 | 0.75 |
| TiO₂ | 10.87 | 8.22 | 13.08 | 13.84 | 13.72 | 13.82 |
| ZrO₂ | | | | 0.11 | | |
| Nb₂O₅ | 26.07 | 29.63 | 27.20 | 29.14 | 29.42 | 22.33 |
| WO₃ | | | | | | |
| Sb₂O₃ | 0.05 | 0.05 | 0.05 | 0.05 | 0.05 | 0.05 |
| total | 100.00 | 100.00 | 100.00 | 100.00 | 100.00 | 100.00 |
| P₂O₅ + B₂O₃ | 40.03 | 38.79 | 36.76 | 35.21 | 33.55 | 34.55 |
| B₂O₃/P₂O₅ | 0.24 | 0.24 | 0.28 | 0.23 | 0.17 | 0.19 |
| TiO₂/P₂O₅ | 0.34 | 0.26 | 0.45 | 0.48 | 0.48 | 0.48 |
| Nb₂O₅/P₂O₅ | 0.81 | 0.94 | 0.95 | 1.02 | 1.03 | 0.77 |
| (Na₂O + K₂O)/(P₂O₅ + B₂O₃) | 0.51 | 0.51 | 0.52 | 0.51 | 0.53 | 0.47 |
| (TiO₂ + Nb₂O₅)/(P₂O₅ + B₂O₃) | 0.92 | 0.98 | 1.10 | 1.22 | 1.29 | 1.05 |
| n_{d} − 1.780000 | −0.070973 | −0.068981 | −0.037320 | −0.012311 | −0.013427 | −0.040963 |
| v_{d} + 40n_{d} − 96.4 | −0.86 | −0.35 | −1.78 | −1.94 | −1.85 | −1.01 |
| n_{d} | 1.709027 | 1.711019 | 1.74268 | 1.767689 | 1.766573 | 1.739037 |
| v_{d} | 27.18 | 27.61 | 24.91 | 23.75 | 23.89 | 25.83 |
| Pg. F | 0.6178 | 0.6147 | 0.6260 | 0.6308 | 0.6300 | 0.6237 |
| λ₈₀ | 408 | 404 | 415 | 427 | 427 | 419 |
| S_{g} | 3.04 | 3.09 | 3.10 | 3.16 | 3.18 | 3.20 |

TABLE 5

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| P₂O₅ | 31.52 | 29.06 | 25.53 | 30.63 | 32.11 | 30.26 |
| SiO₂ | | | 8.60 | | | |
| B₂O₃ | 14.49 | 5.70 | 6.40 | 6.13 | 7.60 | 6.06 |
| Na₂O | 2.88 | 4.47 | 2.78 | 8.22 | 8.62 | 8.13 |
| K₂O | 16.16 | 13.54 | 15.59 | 7.59 | 9.04 | 7.50 |
| BaO | | | | 1.72 | 1.80 | 1.70 |
| ZnO | | | | 1.01 | 1.05 | 0.35 |
| Al₂O₃ | | | | 0.68 | 0.71 | 0.67 |
| TiO₂ | 5.65 | | 14.11 | 10.58 | 11.09 | 10.45 |
| ZrO₂ | | | | 2.34 | 2.07 | 2.32 |
| Nb₂O₅ | 29.13 | 47.23 | 26.89 | 31.05 | 25.86 | 30.68 |
| WO₃ | | | | | | 1.83 |
| Sb₂O₃ | 0.16 | | 0.11 | 0.05 | 0.05 | 0.05 |
| total | 100.00 | 100.00 | 100.00 | 100.00 | 100.00 | 100.00 |
| P₂O₅ + B₂O₃ | 46.01 | 34.76 | 31.92 | 36.76 | 39.71 | 36.32 |
| B₂O₃/P₂O₅ | 0.46 | 0.20 | 0.25 | 0.20 | 0.24 | 0.20 |
| TiO₂/P₂O₅ | 0.18 | 0.00 | 0.55 | 0.35 | 0.35 | 0.35 |
| Nb₂O₅/P₂O₅ | 0.92 | 1.63 | 1.05 | 1.01 | 0.81 | 1.01 |
| (Na₂O + K₂O)/(P₂O₅ + B₂O₃) | 0.41 | 0.52 | 0.58 | 0.43 | 0.44 | 0.43 |
| (TiO₂ + Nb₂O₅)/(P₂O₅ + B₂O₃) | 0.76 | 1.36 | 1.28 | 1.20 | 0.98 | 1.20 |
| n_{d} − 1.780000 | −0.052072 | −0.105750 | | | | |
| v_{d} + 40n_{d} − 96.4 | 0.64 | 1.15 | | | | |
| n_{d} | 1.727928 | 1.67425 | unmeasurable | unmeasurable | unmeasurable | unmeasurable |
| v_{d} | 27.93 | 30.58 | unmeasurable | unmeasurable | unmeasurable | unmeasurable |
| Pg. F | 0.6054 | 0.6044 | unmeasurable | unmeasurable | unmeasurable | unmeasurable |
| λ₈₀ | 408 | 398 | unmeasurable | unmeasurable | unmeasurable | unmeasurable |
| S_{g} | 2.92 | 3.18 | unmeasurable | unmeasurable | unmeasurable | unmeasurable |

From above, it was confirmed that the optical glasses in Examples were highly dispersive and small specific gravity. Further, it was confirmed that the optical glasses in Examples were excellent in transparency with suppressed coloration.

### REFERENCE SIGNS LIST

1: Imaging device
101: Camera body
102: Lens barrel
103: Lens
104: Sensor chip
105: Glass substrate
106: Multi-chip module
2: Multi-photon microscope
201: Pulse laser device
202: Pulse division device
203: Beam adjustment unit
204, 205, 212: Dichroic mirror
206: Objective lens
207, 211, 213: Fluorescence detection unit
208: Condensing lens
209: Pinhole
210: Image forming lens
S: Sample

What is claimed is:

1. An optical glass, comprising: by mass %,
0% to 4% of a SiO₂ component;
10% to 40% of a P₂O₅ component;
4% to 30% of a B₂O₃ component;
1% to 11% of a Na₂O component;
5% to 20% of a K₂O component;
0% to 20% of a TiO₂ component;
0% to 2% of a ZrO₂ component;
0% to 10% of a ZnO component; and
20% to 70% of a Nb₂O₅ component, wherein
P₂O₅ component+B₂O₃ component is more than 25% and 41% or less,
B₂O₃ component/P₂O₅ component is 0.15 or more and less than 1.23,
TiO₂ component/P₂O₅ component is 0 or more and less than 1.3,
Nb₂O₅ component/P₂O₅ component is from 0.7 to 2.8,
(Na₂O component+K₂O component)/(P₂O₅ component+B₂O₃ component) is from 0.42 to 0.8, and
(TiO₂ component+Nb₂O₅ component)/(P₂O₅ component+B₂O₃ component) is from 0.9 to 1.43.

2. The optical glass according to claim 1, further comprising, by mass %, 0% to 20% of a BaO component.

3. The optical glass according to claim 1, further comprising, by mass %, 0% to 10% of an Al₂O₃ component.

4. The optical glass according to claim 1, further comprising, by mass %, 0% to 1% of a Sb₂O₃ component.

5. The optical glass according to claim 1, wherein Ta is not substantially included.

6. The optical glass according to claim 1, wherein a refractive index (n_{d}) with respect to a d-line falls within a range from 1.70 to 1.78.

7. The optical glass according to claim 1, wherein an abbe number (ν_{d}) falls within a range from 20 to 30.

8. The optical glass according to claim 1, wherein the refractive index (n_{d}) with respect to the d-line and the abbe number (ν_{d}) satisfy a relationship that ν_{d}+40×n_{d}−96.4 is 0 or less.

9. The optical glass according to claim 1, wherein specific gravity (S_{g}) is from 2.9 to 3.6.

10. The optical glass according to claim 1, wherein a partial dispersion ratio (Pg, F) is 0.6 or more.

11. The optical glass according to claim 1, wherein a wavelength (λ₈₀) at which an inner transmittance is 80% in a case of an optical path length of 10 mm is 450 nm or less.

12. An optical element using the optical glass according to claim 1.

13. An optical system comprising the optical element according to claim 12.

14. An interchangeable camera lens comprising the optical system according to claim 13.

15. An optical device comprising the optical system according to claim 13.

16. A cemented lens comprising:
a first lens element; and
a second lens element, wherein
at least one of the first lens element and the second lens element comprises the optical glass according to claim 1.

17. An optical system comprising the cemented lens according to claim 16.

18. An interchangeable camera lens comprising the optical system according to claim 17.

19. An optical device comprising the optical system according to claim 17.
